(19) United States
(12) Patent Application Publication
(10) Pub. No.: US 2025/0197218 A1
(43) Pub. Date: Jun. 19, 2025

(54) Apparatus and Method for Nitrogen Generation for Methanol Powered Maritime Vehicle

(71) Applicant: Air Products and Chemicals, Inc., Allentown, PA (US)

(72) Inventors: Jarle Opheim, Kristiansand (NO); Christer Haugland, Kristiansand (NO)

(73) Assignee: Air Products and Chemicals, Inc., Allentown, PA (US)

(21) Appl. No.: 18/544,710

(22) Filed: Dec. 19, 2023

(51) Int. Cl. C01B 21/04; B01D 53/053

(52) U.S. Cl. CPC C01B 21/0438; B01D 53/053; B01D 2253/102; B01D 2256/10; B01D 2259/40009; B01D 2259/4566; C01B 2210/001; C01B 2210/0017

(57) ABSTRACT

An apparatus for nitrogen generation for methanol powered maritime vehicles can include a compression system for compressing air and feeding compressed air to a separation unit for separation of nitrogen and oxygen from the compressed air. The nitrogen can be output from the separation unit for storage at an elevated pre-selected pressure suitable for feeding to a methanol engine of a maritime vehicle (e.g. a ship) for use in purging, leak testing, inerting, or other uses. Embodiments can be configured so there is no heat exchanger or booster compressor positioned between the separation unit and the nitrogen storage unit.

### FIELD

The present invention relates to systems and apparatus for maritime vehicles such as boats or ships that utilize methanol as a fuel for powering at least one engine and methods of making and using the same.

### BACKGROUND

Cargo ships or oil tankers can transport material over waterways (e.g. oceans, seas, rivers, etc.). Such vessels can be powered by methanol fuel. Wärtsilä and MAN Energy Solutions have disclosed methanol fueled engines for ships. Chinese Patent Application Publication No. CN113047994A discloses a ship that can utilize methanol as a fuel. Japanese Patent Application Publication No. JP2019070387A discloses a dual fuel injection device that can inject methanol as a fuel.

### SUMMARY

The use of methanol as a fuel option for ship engines can often require use of gaseous nitrogen to perform leak testing and other actions in association with use of the methanol fuel. A new apparatus and process for forming gaseous nitrogen from air and storing the formed nitrogen (N2) for use in such applications can provide improved reliability and reduced footprint for supporting use of methanol as a fuel. Such embodiments can facilitate the use of methanol as a green energy source that can help reduce reliance on fossil fuels and improve the environmental impact associated with ship operation and maintenance.

Some embodiments of the apparatus and process described herein can generate nitrogen from air without requiring use of any booster compressors between a separator, which separates nitrogen and oxygen from a feed of compressed air, and a nitrogen storage unit, which can store the separated nitrogen output from the separator at a pre-selected pressure (e.g. a pressure of over 13 bar gauge (barg), or over 1300 kPa gauge (kPag), a pressure of between 10 barg and 16 barg or 1000 kPag and 1600 kPag, etc.). Some embodiments can also avoid use of a heat exchanger for heating or cooling the nitrogen output from the separation unit before it is fed to the nitrogen storage unit as well.

Some embodiments can generate and store nitrogen gas that is at least 95 volume percent (vol %) nitrogen (N2), or between 95 and 100 vol % N2, for storage at a pressure of between 10 and 16 barg or between 1000 and 1600 kPag. Such generation and storage can be provided without use of intermediate heat exchangers and/or booster compressors between the nitrogen/oxygen separation and storage units to provide a reduced footprint and improved reliability by reducing the equipment that can be needed to generate and store the nitrogen gas. While such heat exchangers and/or boosters may not be used between the nitrogen/oxygen separation unit and the nitrogen storage unit, process elements that may utilize the stored nitrogen gas downstream of the nitrogen storage unit may include such elements for a particular application (e.g. purging, etc.). In yet other applications, there may not be any such booster or heat exchanger, as the stored nitrogen may be at a sufficient pressure and temperature for one or more uses or applications downstream of the nitrogen storage unit.

Reducing the footprint and amount of equipment helps to reduce maintenance operations and improve reliability by limiting the number and type of equipment that can fail or require maintenance or repair during operation while also reducing the capital costs associated with the fabrication and installation of the apparatus. Less equipment may also reduce the energy costs associated with operation of the apparatus in some embodiments.

In a first aspect, an apparatus for nitrogen generation for a methanol powered maritime vehicle can include a compression system configured to compress air to a pre-selected feed pressure and provide a compressed air flow at the pre-selected feed pressure. A nitrogen separation unit can be positioned downstream of the compression system. The nitrogen separation unit can be configured to separate nitrogen (N2) and oxygen (O2) from the compressed air flow fed to the nitrogen separation unit via the compression system positioned upstream of the nitrogen separation unit. The nitrogen separation unit can be configured to produce a nitrogen stream comprising the nitrogen separated from the compressed air flow (e.g. an N2-rich stream), at least a portion of which may be fed to an nitrogen storage unit.

In a second aspect, the pre-selected feed pressure is over 1300 kPa gauge (kPag) and is less than 2000 kPag. The pre-selected feed pressure can be selected so that the nitrogen stream is formed and fed to the nitrogen storage unit without a booster compressor (e.g. without a booster compressor positioned between the nitrogen storage unit and the nitrogen separation unit).

For example, the compression system can include a compressor and the pre-selected feed pressure can be over 1300 kPag, such that the nitrogen stream is fed to the nitrogen storage unit with the compressor of the compression system being the only compressor utilized for separation of the nitrogen and feeding of the nitrogen stream to the nitrogen storage unit.

In a third aspect, the apparatus can include a filtration system having at least one filter element positioned between the compression system and the nitrogen separation unit to filter the compressed air flow before the compressed air flow is fed to the nitrogen separation unit. The filtration unit can be configured to filter particulates, lubricant, oil, and/or other impurities from the compressed air. In some embodiments, the filtration system can include one or more coalescing filters, for example.

In a fourth aspect, the apparatus can include a pretreatment unit positioned between the filtration system and the nitrogen separation unit to pre-heat and/or dry the compressed air flow before the compressed air flow is fed to the nitrogen separation unit. Drying can be provided via a refrigerant drier, desiccant based drier, membrane dryer, or other type of drier, for example.

In a fifth aspect, the apparatus can include the nitrogen storage unit. The nitrogen storage unit can include a tank, a plurality of tanks, a vessel, a plurality of vessels, or other arrangement of storage devices for storage of the nitrogen gas output from the nitrogen separation unit (e.g. gas having an N2 content of between 95 and 100 vol % N2).

In a sixth aspect, the nitrogen separation unit can include one or more membranes or can be comprised of an adsorption system. In some embodiments, an adsorption system can be a pressure swing adsorption (PSA) system. Other embodiments can utilize one or more membranes (e.g. a single membrane, a plurality of membranes that operate in parallel and/or a plurality of membranes that operate in series, etc.). For instance, the nitrogen separation unit can include at least one membrane for forming the nitrogen stream and an O2-enriched stream, wherein the O2-enriched stream output from the nitrogen separation unit is vented and the nitrogen stream formed is an N2-rich stream that is at least 90 vol % N2 or is between 95 100 vol % N2.

In a seventh aspect, the maritime vehicle can be a ship. For example, the maritime vehicle can be a cargo ship, barge, tanker, or other type of ship.

In an eighth aspect, the apparatus can include the nitrogen storage unit and a methanol engine unit. The nitrogen storage unit can be positioned to output nitrogen stored in the nitrogen storage unit to the methanol engine unit via a methanol engine feed conduit positioned between the nitrogen storage unit and the methanol engine unit. In some embodiments, the nitrogen storage unit can also be connected to a supplemental nitrogen feed conduit for feeding nitrogen to one or more other elements of the maritime vehicle.

In a ninth aspect, the apparatus of the first aspect can include one or more features of the second aspect, third aspect, fourth aspect, fifth aspect, sixth aspect, seventh aspect, and/or eighth aspect. It should therefore be appreciated that other embodiments can utilize other combinations of features. Examples of such features can be appreciated from the exemplary embodiments discussed herein.

For instance, in some embodiments an apparatus for nitrogen generation for a methanol-powered maritime vehicle includes a compression system configured to compress air to a pre-selected feed pressure and provide a compressed air flow at the pre-selected feed pressure and a nitrogen separation unit positioned downstream of the compression system that is configured to separate nitrogen and oxygen from the compressed air flow fed to the nitrogen separation unit via the compression system. The nitrogen separation unit can be configured to output the nitrogen separated from the compressed air flow as a nitrogen stream, at least a portion of which is fed to a nitrogen storage unit via a nitrogen storage unit feed conduit connected between the nitrogen storage unit and the nitrogen separation unit. The nitrogen storage unit can be connected to a methanol engine unit via a methanol feed conduit to feed nitrogen stored in the nitrogen storage unit to the methanol engine unit. A nitrogen venting conduit can be positioned between the nitrogen separation unit and the nitrogen storage unit to vent at least a portion of the nitrogen stream. The nitrogen venting conduit can have a valve. A sensor can be positioned to detect a pressure of the nitrogen storage unit, and a controller having a processor communicatively connected to a non-transitory memory can be communicatively connected to the sensor and the valve of the nitrogen venting conduit. The controller can be configured to determine whether the pressure of the nitrogen storage unit is at or above a pre-selected pressure threshold based on data from the sensor and, in response to whether the pressure of the nitrogen storage unit is at or above the pre-selected pressure threshold, actuate the valve of the nitrogen venting conduit to adjust the valve of the nitrogen venting conduit to an open position to vent at least a portion of the nitrogen stream. The controller can also be communicatively connected to the compression system to actuate deactivation of the compression system in response to whether the pressure of the nitrogen storage unit is at or above the pre-selected pressure threshold. The controller can also be configured to communicate with a sensor positioned to detect the nitrogen purity of the nitrogen stream to monitor the nitrogen content of this stream to make sure that steam is a sufficiently N2-rich stream (e.g. having an N2 content of at least 95 vol % or at least 97 vol %, etc.).

In some embodiments, the controller can also be configured to communicate with the nitrogen purity sensor to determine the oxygen content of the nitrogen stream and, when the oxygen content is at or above a pre-selected threshold (e.g. 3 vol % 02, 5 vol % O2, etc.) determine that the nitrogen content of the nitrogen stream is too low and communicate with the valve of the nitrogen venting conduit to open that valve and also communicate with the valve of the nitrogen storage unit feed conduit to close that valve so that the low purity nitrogen is vented instead of fed to the nitrogen storage unit. In response to receiving data from the nitrogen purity sensor indicating that the nitrogen content of the nitrogen stream is at or above the pre-selected nitrogen purity threshold (e.g. the oxygen content of the nitrogen stream is at or below 3 vol % or 5 vol %, 10 vol % or other pre-selected threshold, etc.) the controller can communicate with the valve of the nitrogen venting conduit to close that valve and communicate with the valve of the nitrogen storage unit feed conduit to open that valve so that the sufficiently pure nitrogen stream is fed to the nitrogen storage unit for storage therein.

In a tenth aspect, a process for nitrogen generation for a methanol powered maritime vehicle is provided. Embodiments of the process can include compressing air to a pre-selected feed pressure to output a compressed air flow. The pre-selected feed pressure can be greater than 1300 kPag and less than 2000 kPag. The process can also include separating the compressed air flow to form a nitrogen stream having at least 90 vol % N2 and less than 100 vol % N2 and feeding the formed nitrogen stream to a nitrogen storage unit connected to a methanol engine unit.

Embodiments of the process can be implemented by an embodiment of the apparatus for nitrogen generation for a methanol powered maritime vehicle. The formed nitrogen stream can be considered an N2-rich stream.

In an eleventh aspect, the process can also include feeding nitrogen from the nitrogen storage unit to the methanol engine unit for leak testing and/or purging.

In a twelfth aspect, the pre-selected feed pressure can be selected so that the nitrogen stream is formed and fed to the nitrogen storage unit without a booster compressor.

In a thirteenth aspect, the feed air can be compressed by a compression system comprising a compressor, and the pre-selected feed pressure can be selected so that the nitrogen stream is fed to the nitrogen storage unit with the compressor of the compression system being the only compressor utilized for separating the compressed air flow and feeding the nitrogen stream to the nitrogen storage unit.

In a fourteenth aspect, the process can also include filtering the compressed air flow upstream of separating the compressed air flow to form the nitrogen stream, pretreating the compressed air flow to dry and/or pre-heat the compressed air flow upstream of separating the compressed air flow to form the nitrogen stream, and/or removing oil vapor and/or lubricant from the compressed air flow upstream of separating the compressed air flow to form the nitrogen stream.

In a fifteenth aspect, the process can also include detecting a pressure of the nitrogen storage unit. In response to whether the pressure of the nitrogen storage unit is at or above a first pressure threshold, the nitrogen stream can be vented and/or a compression system can be deactivated to cease compressing the feed air. In response to whether the pressure of the nitrogen storage unit is at or below a second pressure threshold, the compression system can be activated to initiate compressing the feed air and/or venting the nitrogen stream can be prevented.

In some embodiments, venting of the nitrogen stream can also occur based on a detected nitrogen purity of the nitrogen stream. For instance, in response to whether an oxygen content within the nitrogen stream output from a nitrogen separation unit is too high (e.g. over 3 vol %, 5 vol %, 10 vol % or other pre-selected oxygen threshold indicating that the nitrogen purity is too low), the nitrogen stream can be vented so the nitrogen stream having insufficient nitrogen purity is not fed to a storage unit for storage and subsequent use. In response to whether the oxygen content within the nitrogen stream is sufficiently low (e.g. no more than 3 vol %, no more than 5 vol %, no more than 10 vol % or other pre-selected oxygen threshold indicating that the nitrogen purity is at a per-selected concentration such as 97 vol %, 95 vol %, 90 vol % or other pre-selected purity threshold), venting of the nitrogen stream can be stopped and the nitrogen stream having sufficient nitrogen purity can be fed to a storage unit for storage and subsequent use of the nitrogen stream (which can be considered an N2-rich stream).

In a sixteenth aspect, the process of the tenth aspect can include one or more features of the eleventh aspect, twelfth aspect, thirteenth aspect, fourteenth aspect, and/or fifteenth aspect. It should therefore be appreciated that other embodiments can utilize other combinations of features. Examples of such features can be appreciated from the exemplary embodiments discussed herein.

Other details, objects, and advantages of the apparatus described herein for nitrogen generation for methanol powered maritime vehicles, processes for nitrogen generation for methanol powered maritime vehicles, and methods of making and using the same will become apparent as the following description of certain exemplary embodiments thereof proceeds.

### BRIEF DESCRIPTION OF THE DRAWINGS

Exemplary embodiments of the present invention are shown in the drawings included herewith, where like reference characters used in the drawings may identify like components.

FIG. 1 is a block diagram illustrating a first exemplary embodiment of an apparatus for nitrogen generation for methanol powered maritime vehicles. An exemplary embodiment of the process for nitrogen generation for methanol powered maritime vehicles can also be appreciated from FIG. 1.

FIG. 2 is a block diagram of an exemplary embodiment of a controller CTRL that can be utilized in the first exemplary embodiment of the apparatus for nitrogen generation for methanol powered maritime vehicles shown in FIG. 1.

FIG. 3 is a flow chart illustrating a first exemplary embodiment of a process for nitrogen generation for methanol powered maritime vehicles. An embodiment of the apparatus for nitrogen generation for methanol powered maritime vehicles can implement an embodiment of this process.

### DETAILED DESCRIPTION OF EXEMPLARY EMBODIMENTS

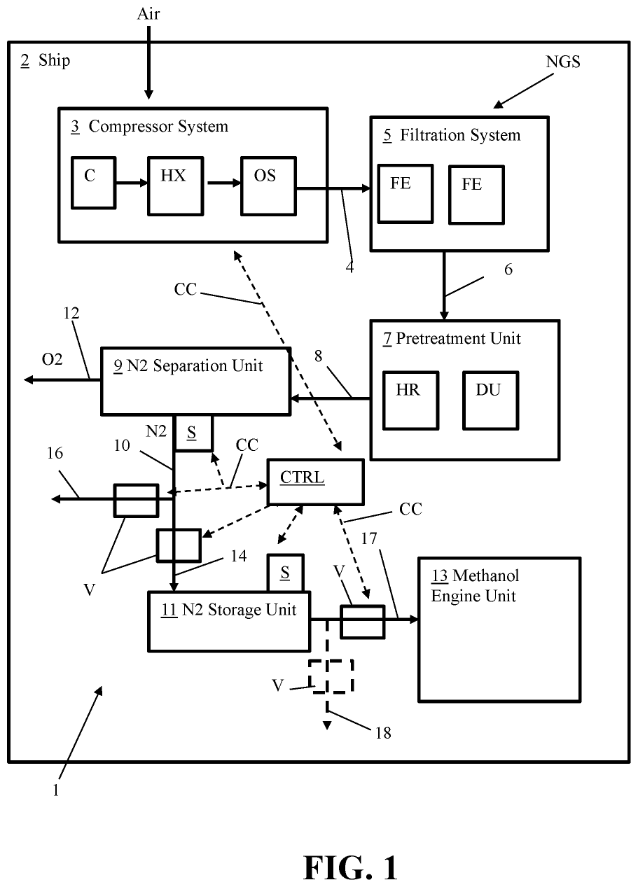

Referring to FIGS. 1-3, an exemplary embodiment of the apparatus 1 for nitrogen generation for methanol powered maritime vehicles can include a ship 2. The ship 2 is a type of maritime vehicle that can have a methanol engine unit 13. The methanol engine unit 13 can power propulsion of the ship 2 as well as other features of the ship (e.g. electricity generation for powering equipment of the ship, etc.). In some embodiments, the ship 2 can also be powered by diesel, oil, natural gas, or another type of fuel as well. The methanol engine unit 13 can be a dual fuel type engine unit that can switch between different fuel sources or can be an engine only adapted for use of methanol. If the ship 2 can utilize another fuel and the methanol engine unit 13 is configured to only utilize methanol fuel, the ship 2 can have a separate engine for use of that other fuel in such an embodiment.

The ship 2 can include a nitrogen generation system NGS. The nitrogen generation system can include a feed compression system 3 that can compress air surrounding the ship and feed compressed air to a filtration system 5.

The compression system 3 can include a compressor C that can compress the air to a pre-selected feed pressure. The pre-selected feed pressure can be at least 1300 kPag, between 1300 and 1700 kPag, or at least 1500 kPag (e.g. between 1500 and 2000 kPag). In other embodiments, the pre-selected feed pressure can be at least 1400 kPag or another suitable pressure within a pre-selected pressure range. The pre-selected feed pressure can be selected so that nitrogen (N2) formed via a downstream nitrogen separation unit 9 can be fed to a nitrogen storage unit 11 without the use of a booster compressor or heat exchanger between the nitrogen separation unit 9 and nitrogen storage unit 11. In some embodiments, the feed pressure can be selected so that no additional compressor is needed for the nitrogen generation system NGS (e.g. the compressor C of the compression system 3 is the only compressor of the nitrogen generation system NGS).

The compressor C of the compression system can be a single stage compressor or can include multiple stages. The compression system 3 can also include at least one heat exchanger HX for cooling the compressed feed air and/or compressor. The heat exchanger HX can utilize water or salt water as a cooling medium for the heat exchanger in some embodiments. In some embodiments, the heat exchanger HX can be a chiller or an air cooler that utilizes air, sea water, or water as the cooling medium of the chiller, for example.

The compression system 3 can also include an oil separator OS that can be configured to remove oil or other compressor lubricant that may be utilized in the compressor C for movement of vanes, a screw, or other element of the compressor C. The oil separator OS can be or include at least one cyclone or other type of oil separation or lubricant separation element that can remove lubricant and/or oil from the compressed air before that compressed air is fed downstream to the filtration system 5 and/or the nitrogen separation unit 9.

The filtration system 5 can be downstream of the compression system 3 and can receive the compressed air from the compression system 3. In some embodiments, the compressed air can be fed to the filtration system 5 via a compressed air feed conduit 4 connected between the filtration system 5 and the compression system 3.

The filtration system 5 can be configured to filter particulates, oil, lubricant, or other elements from the air and output a filtered compressed air flow to a pretreatment unit 7 and/or the nitrogen separation unit. For example, the filtration system 5 can include at least one filter element FE. Each filter element FE can be coalescing filter, activated carbon filter, or other type of filter configured to remove particulates, oil, liquid water, and/or other impurities from the compressed air output from the compression system 3.

The filtered compressed air can be output from the filtration system 5 and fed to a pretreatment unit 7 via a pretreatment unit feed conduit 6 positioned between the filtration system 5 and the pretreatment unit 7.

The pretreatment unit 7 can be configured to pre-heat and/or dry the compressed and filtered air before feeding that air to the nitrogen separation unit 9. For example, the pretreatment unit 7 can include a pre-heater (HR) and/or a drier unit (DU). The pre-heater HR can pre-heat the compressed air to a pre-selected separation feed temperature. For example, the pre-heater can be an electric heater, an electric trim heater, or other type of preheater for pre-heating the air before it is fed to the nitrogen separation unit 9. The pre-selected separation feed temperature can be between 10° C. and 75° C. or between 30° C. and 60° C. Other suitable temperature ranges that can heat the compressed air to a desired temperature to help facilitate separation of the oxygen from the nitrogen of the compressed air can also be utilized.

The drier unit (DU) can include at least one desiccant for removing moisture from the air (e.g. silica and/or other desiccant for removal of water vapor from the air). For instance, the drier unit DU can include a vessel having desiccant therein that can contact the compressed and filtered air for removal of water vapor from the air. In other embodiments, the drier unit (DU) can be a membrane dryer or a refrigerant type of dryer.

In some embodiments, the drier unit (DU) can be located in a different position between the compressor C of the compression system 3 and the nitrogen separation unit 9. For instance, in some alternative arrangements, a drier unit (DU) can be positioned between the filtration system 5 and the compression system 3.

The pretreatment unit 7 can also include an adsorber, a vessel having a bed of activated carbon, and/or an activated carbon filter that can be positioned and configured for removal of oil vapor and/or other impurity from the compressed air before it is fed to the nitrogen separation unit 9.

The compressed air can be output from the pretreatment unit 7 and fed to the nitrogen separation unit 9 via a nitrogen separation unit feed conduit 8 positioned between the pretreatment unit 7 and the nitrogen separation unit 9.

In other embodiments, the pretreatment unit 7 may not be utilized. In such an embodiment, the filtered compressed air output from the filtration unit 5 can be fed to the nitrogen separation unit 9 from the filtration system 5 via a nitrogen separation unit feed conduit 8 positioned between the nitrogen separation unit 9 and the filtration system 5. In embodiments that may also not include the filtration system 5, the compressed air output from the compression system 3 can be fed to the nitrogen separation unit 9 via a nitrogen separation unit feed conduit 8 positioned between the nitrogen separation unit 9 and the compression system 3.

The nitrogen separation unit 9 can include at least one membrane or an adsorption system for separating oxygen (O2) from nitrogen (N2) in the compressed air to form an O2-enriched stream and an N2-rich stream. The O2-enriched stream can be vented, and the N2-rich stream can be fed to a nitrogen storage unit 11.

In embodiments that utilize an adsorption system, the adsorption system can be a pressure swing adsorption (PSA) system in some embodiments. In such an embodiment, adsorbent material within one or more adsorbers of the adsorption system can adsorb oxygen to separate the oxygen from the nitrogen to form the N2-rich stream. The N2-rich stream can be output via a nitrogen output conduit 10 that is connected to the nitrogen separation unit 9 and is positioned between the nitrogen storage unit 11 and the nitrogen separation unit 9 for feeding nitrogen to the nitrogen storage unit 11 and/or for venting an excess of the nitrogen that may not be stored in the nitrogen storage unit 11. Regeneration of one or more adsorbers of the adsorption system can result in formation of the O2-enriched stream, which may be vented via an oxygen venting conduit 12 in embodiments that utilize an adsorption system for the nitrogen separation unit 9.

In embodiments that utilize at least one membrane, the at least one membrane can be a membrane unit having at least one membrane (e.g. one membrane or a plurality of membranes arranged in series or in parallel) configured to permeate oxygen from compressed air to form an O2-enriched stream and the high purity N2-rich stream (e.g. a stream having at least 95 vol % N2). The O2-enriched stream formed from the membrane(s) can be output via the oxygen venting conduit 12. The high purity nitrogen stream can be fed to the nitrogen storage unit 11 and/or vented via a nitrogen output conduit 10 positioned between the nitrogen separation unit 9 and the nitrogen storage unit 11.

The nitrogen separation unit 9 can output an N2-rich stream via the nitrogen output conduit 10 that comprises between 95 and less than 100 vol % N2. In other embodiments, the N2-rich stream can have another nitrogen composition (e.g. greater than 90 vol % N2, between 85 and 100 vol % N2, etc.).

The O2-enriched stream can include a significant amount of oxygen. For example, the formed O2-enriched stream can comprise greater than 0 and less than or equal to 50 vol % O2, can be between 10 and 40 vol % O2, or can be between 25 and 40 vol % O2. The O2-enriched stream can be vented to atmosphere adjacent the ship 2 via the oxygen venting conduit 12.

The nitrogen output conduit 10 can be connected to a nitrogen storage unit feed conduit 14. The nitrogen storage unit feed conduit 14 can include a valve V that is adjustable between an open position and a closed position to feed nitrogen to the nitrogen storage unit 11. If the valve V of the nitrogen storage unit feed conduit 14 is closed, then the closed valve can vent the entirety of the N2-rich stream via the nitrogen venting conduit 16. The valve V of the nitrogen storage unit feed conduit 14 can be closed when a sensor S detects that the nitrogen storage unit 11 is full or is at a pre-selected pressurization level (at or above a first pre-selected nitrogen storage unit pressure threshold) and cannot receive further nitrogen gas, for example.

The valves V of the nitrogen storage unit feed conduit 14 and nitrogen venting conduit 16 can have multiple different open positions and can both be opened at different opened positions so that a portion of the formed N2-rich stream can be vented while another portion is fed to the nitrogen storage unit for storage. Such partial venting may be performed when the nitrogen storage unit 11 is detected as being mostly full or having a limited capacity that is unable to receive the entirety of the N2-rich stream based on data obtained via at least one sensor S positioned to detect the extent to which the nitrogen storage vessel 11 is full and/or the pressure of the nitrogen storage unit 11.

For example, a controller CTRL can be communicatively connected to the valves V of the nitrogen venting conduit 16 and the nitrogen storage unit feed conduit 14 as well as (i) a sensor S that can detect the pressure of the nitrogen storage unit 11 and/or (ii) a sensor S positioned to detect an nitrogen purity level of the N2-rich stream fed to the nitrogen output conduit 10 to receive data from the sensor(s) S and provide communications to one or both of the valves V for adjustment of their positions to facilitate venting of nitrogen or feeding of nitrogen to the nitrogen storage unit 11 based on the purity of the N2-rich stream output from the nitrogen separation unit 9 and/or pressure of the nitrogen storage unit 11 detected by the sensor 11. The controller CTRL can also be communicatively connected to the compression system 3 to adjust operation of the compression system 3 between an on state and an off state.

For instance, when the nitrogen storage unit 11 is at or above a pre-selected pressure threshold (e.g. a pre-selected full capacity threshold or a first pre-selected pressure threshold), the controller CTRL can communicate with the compression system 3 via a communicative connection between the controller CTRL and the motor of the compressor C or a control element of the compressor C to actuate the deactivation of the compression system to stop further generation of nitrogen or further generation and storage of nitrogen from the air. Examples of this pre-selected pressure threshold can be 1600 kPag, 1000 kPag, or other suitable pressure. For example, the pre-selected pressure threshold can be a pressure value between 10 barg (1000 kPag) and 16 barg (1600 kPag) or between 10 barg (1000 kPag) and 13.5 barg (1350 kPag).

When the nitrogen storage unit 11 is at or below a pre-selected nitrogen capacity threshold (e.g. a second pre-selected pressure threshold that is lower than the first pre-selected pressure threshold or pre-selected full capacity threshold), the controller CTRL can communicate with the compression system 3 to activate the compression system so that the compression system 3 compresses air to be fed to the nitrogen separation unit 9 for further generation and storage of nitrogen or further generation and storage of nitrogen from the air. Examples of the pre-selected nitrogen capacity threshold include a nitrogen nitrogen storage unit 11 pressure below 10 barg (e.g. 800 kPa, 900 kPag, between 900 kPag and 1000 kPag, etc.), below 13 barg (1300 kPag) or between 10 barg and 14 barg (e.g. between 1000 kPag and 1400 kPag).

The controller CTRL can also be configured to control valve positions based on nitrogen purity levels that are detected. For instance, the nitrogen output conduit 10 can be connected to a nitrogen venting conduit 16 that has a valve V that can be adjusted between an open position and a closed position to vent the N2-rich stream or vent of a portion of the N2-rich stream output from the nitrogen separation unit 9. A sensor S can be positioned to detect the nitrogen purity of the N2-rich stream. In some configurations, this sensor S can provide data to the controller CTRL to monitor the oxygen concentration of the N2-rich stream to evaluate the nitrogen purity of that stream, for example. When the nitrogen purity is below a pre-selected nitrogen purity threshold (e.g. oxygen content is over 10 vol %, over 5 vol %, over 3 vol %, or over another pre-selected oxygen content threshold that corresponds to a pre-selected nitrogen purity threshold, etc.), then the controller can communicate with the valves V so that the valve of the nitrogen venting conduit 16 can be opened and the valve V of the nitrogen storage unit feed conduit 14 can be closed so that the low nitrogen purity N2-rich stream is vented and not stored. When the controller CTRL determines that the nitrogen purity is at or above the pre-selected nitrogen purity threshold based on the nitrogen purity sensor data (e.g. oxygen content is less than or equal to 10 vol %, less than or equal to 5 vol %, less than or equal to 3 vol %, etc.), then the controller CTRL can communicate with the valves so that the valve V of the nitrogen venting conduit 16 can be closed and the valve V of the nitrogen storage unit feed conduit 14 can be opened so that the N2-rich stream having an acceptable nitrogen concentration can be fed to the nitrogen storage unit 11 for storage therein.

The nitrogen stored in the nitrogen storage unit 11 can be fed to a methanol engine unit 13 of the ship 2. For example, nitrogen from the nitrogen storage unit 11 can be stored at a pre-selected nitrogen storage pressure. The pre-selected nitrogen storage pressure can be between 10 barg and 16 barg (1000 kPag to 1600 kPag) in some embodiments. The nitrogen gas can be output from the nitrogen storage unit 11 by opening a valve V of a methanol engine feed conduit 17 to feed nitrogen from the nitrogen storage unit 11 to the methanol engine unit 13. The nitrogen gas can be fed to the methanol engine unit 13 for leak testing, purging, and/or inerting operations, for example.

In some applications, the nitrogen storage unit 11 can be utilized for leak testing operations. In such applications, the pressure threshold for starting operation of the compression system 3 can be lower than 13 barg and the pressure threshold for actuating cessation of the compression system can be greater than 13 barg. In some configurations, the apparatus can be configured to run continuously during leak testing to provide a high-pressure flow of nitrogen to the methanol engine 13 for leak testing so that the high-pressure flow of nitrogen is fed to the methanol engine unit 13 at a maximum pressure for the apparatus.

In some embodiments, the nitrogen gas can also be output from the nitrogen storage unit 11 via a supplemental nitrogen output conduit 18 (shown in broken line) to feed nitrogen to other ship elements. The nitrogen gas can be fed to the other elements by opening a valve V of the supplemental nitrogen output conduit 18.

The nitrogen storage unit 11 can also include a pressure relief valve and/or a venting valve that can be actuated to vent nitrogen to alleviate an over pressurization condition. Such venting can be separate from the methanol engine feed conduit 17 and the supplemental nitrogen output conduit 18.

In some configurations, the at least one sensor S can also include a nitrogen purity sensor that is in communication with the controller CTRL and can detect the nitrogen content of the stored nitrogen gas within the nitrogen storage unit 11. The nitrogen purity sensor can detect nitrogen purity by detecting the oxygen content within the nitrogen gas or detecting another parameter to indicate nitrogen purity. In some configurations, the nitrogen purity that is detected can be used to actuate venting of the nitrogen storage unit 11 and/or feeding the nitrogen from the nitrogen storage unit 11 to at least one downstream element (e.g. methanol engine unit 13, other downstream use via supplemental conduit 18, etc.).

Also (as noted above), if upon actuation of the compression system 3, the nitrogen purity being output from the nitrogen separation unit 9 is detected as being below a pre-selected threshold, the nitrogen may be vented until higher purity nitrogen is formed that meets the nitrogen purity threshold. In response to detecting that the nitrogen stream output from the nitrogen separation unit has sufficient nitrogen purity, the controller CTRL can communicate with at least one valve V to adjust the valve position and feed the nitrogen from the nitrogen separation unit 9 to the nitrogen storage unit 11.

The controller CTRL can also be in communication with the valve V of the methanol engine feed conduit 17 and the valve V of the supplemental nitrogen feed conduit 18 (when utilized). The controller CTRL can communicate with these one or more valves V to adjust their positions between at least one open position and a closed position based on user input communicated to the controller or other criteria of a pre-defined control scheme stored in the memory of the controller CTRL. For instance, a valve V can be adjusted from its closed position to an open position, from one open position to another open position, or from an open position to a closed position based on a pre-defined control criteria stored in the memory of the controller CTRL.

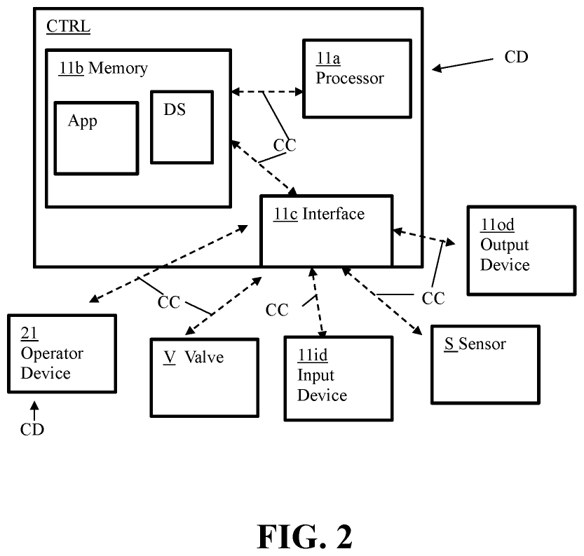

As may best be seen from FIG. 2, the controller CTRL can be a computer device CD. The controller can include a processor 11a in communication with non-transitory memory 11b (Memory) that has one or more applications (App) stored thereon and a number of data stores (DS) stored thereon. The controller can also include one or more interfaces 11c (Interface) in communication with the processor 11a. Each interface 11c can include a transceiver for communicating with one or more input devices 11id, one or more output devices 11od, one or more sensors S (e.g. nitrogen storage unit pressure sensor S, nitrogen purity sensor S, etc.), one or more other computer devices CD, and/or one or more valves V. The transceiver(s) of the interface 11c can include at least one local area network connection transceiver, at least one wide area network connection transceiver, and/or at least one near field communication transceiver. The transceiver(s) can be configured to communicate via wireless and/or hard-wired connections.

It should be appreciated that at least some connections CC can utilize other elements to facilitate communication. For example, some wireless connections can involve use of an access point, router, or intermediate nodes.

Examples of input devices 11id that can be connected to the controller can include buttons, a keypad, a keyboard, a stylus, a microphone, or a touch screen. Examples of output devices 11od that can be connected to the controller CTRL can include a display, a printer, and/or a speaker. For example, the controller can be configured to illustrate a graphical user interface (GUI) on a display to enable a user to provide input to the controller by interacting with the GUI via a touch screen display, pointer device and/or keyboard.

In some embodiments, the controller can be in communication with an operator device 21, which can be a computer device CD configured to run an automated process control system or other type of process control scheme that includes the controller and various elements of the ship 2 and/or the apparatus 1 for nitrogen generation to which the controller is connected. The automated process control system of the operator device 21 can oversee and/or help monitor operations of the ship 2, the methanol engine unit 13, and/or related operations, for example.

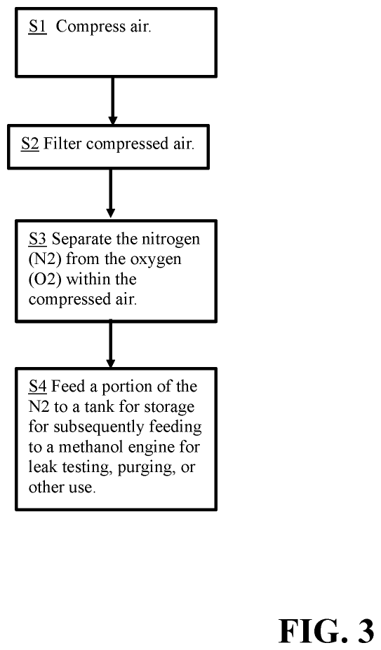

Embodiments of the apparatus 1 for nitrogen generation for methanol powered maritime vehicles and/or the controller CTRL can be configured to implement an embodiment of the process for nitrogen generation for methanol powered maritime vehicles. An exemplary embodiment of such a process is shown in FIG. 3.

In a first step S1, feed air can be compressed. Such compression can occur via a compression system 3 as discussed above so that the air is compressed to a pre-selected feed pressure that avoids any need for further compression of the air between the compression system 3 and the nitrogen storage unit 11, for example.

In a second step S2, the compressed air can be filtered. For example, the compressed air can be passed through one or more filter elements FE of a filtration system 5 and/or passed through an oil separator OS as discussed above.

In a third step S3, the compressed air can be passed through a nitrogen separation unit 9 so that nitrogen from the compressed air can be separated from oxygen of the compressed air. The oxygen separated from the nitrogen can be vented (e.g. as a formed O2-enriched gas as discussed above). The nitrogen that is separated from the oxygen can be fed to the nitrogen storage unit 11 and/or vented based on (i) a determined purity of the nitrogen that is generated, (ii) a determined pressure of the nitrogen storage unit 11 and/or (iii) a detected fullness of the nitrogen storage unit 11 (e.g. as an N2-rich stream as discussed above). Examples of such venting and/or feeding of the nitrogen to the nitrogen storage unit 11 can be appreciated from the above.

In a fourth step S4, a portion of the nitrogen can be fed to the nitrogen separation unit 11 for storage and for subsequently feeding the nitrogen to the methanol engine unit 13 via nitrogen methanol feed conduit 17 and/or other ship element via supplemental nitrogen feed conduit 18. The nitrogen fed to the nitrogen methanol engine unit 13 can be used in leak testing, purging, and/or other use.

Embodiments of the process can also include other steps. For example, a valve of the nitrogen storage unit feed conduit can be closed and a venting conduit valve V can be opened based on a detected pressure of the nitrogen storage unit 11. As another example, one or more valves can be adjusted between their opened and closed position based on a detected purity of nitrogen that is output from the nitrogen separation unit 9 as discussed above. As another example, the compression system 3 can be activated or deactivated based on a detected pressure of the nitrogen storage unit 11 as discussed above (and valve positions can be adjusted to account for nitrogen purity that occurs after the compression system is started as discussed above). As yet another example, the compressed air can be purified via a pretreatment unit 7 to remove one or more impurities (e.g. oil vapors, water, etc.) and/or pre-heat the compressed air before the air is fed to nitrogen separation unit 9 for forming the high purity nitrogen stream (e.g. nitrogen content of at least 95 to 100 vol %, a nitrogen content of at least 97 vol %, a nitrogen stream having an oxygen content less than or equal to 3 vol %, or less than or equal to 5 vol %, etc.) for feeding to the nitrogen storage unit 11 as discussed above.

Embodiments of the present process and apparatus for nitrogen generation and storage can provide improved efficient operation that can reduce the footprint of a nitrogen generation system NGS and allow for a more reliable system that has less equipment and less moving parts that can be subject to mechanical failure or other maintenance issues. Embodiments can provide improved operational flexibility, improved operational performance, and improved reliability. Further, embodiments of the present invention can facilitate the use of methanol as a fuel source so that more ships and other maritime vehicles can be designed or retrofit to use methanol as a fuel source, which provides an alternative to fossil fuel-based fuel sources and provides an improved environmental impact for operation of a ship 2 or other maritime vehicle.

It should be appreciated that different modifications to different elements can be made to meet a pre-selected set of design criteria. For example, the type of nitrogen separation unit that is utilized (e.g. membrane, adsorption system, etc.) can be any type of suitable system. Some embodiments can utilize a membrane unit that comprising a hollow fiber membrane(s), spiral wound membrane(s) or other suitable membrane(s). Other embodiments may utilize a pressure swing adsorption system having two or more adsorbers, or other type of adsorption system (e.g. a vacuum pressure adsorption system, a temperature swing adsorption system, etc.).

As another example, the nitrogen storage unit 11 can include a tank or other vessel for storage of nitrogen or a plurality of storage vessels for storage of the nitrogen. For example, the nitrogen storage unit 11 can include a single storage tank, a plurality of storage tanks, or other assembly of storage vessels and/or tanks.

As yet another example, the filtration system 5 can include one more filter elements FE (e.g. include a single filter element, include multiple filter elements that operate in series, include multiple filter elements that operate in parallel, etc.).

As yet another example, the compression system 3 can be configured as any type of suitable compression system (e.g. single stage compression, multiple stage compression, etc.) for providing a feed of compressed air at a pre-selected feed pressure and/or a pre-selected feed temperature. In embodiments of the compression system 3 that may not include an oil separator OS, an oil separator mechanism can be positioned between the compression system 3 and the nitrogen separation unit 9 (e.g. an activated carbon adsorber or filter element can be utilized as discussed above, etc.).

The different conduits and conduit arrangements can also be adjusted to meet a pre-selected set of design criteria. The conduits can include different types of piping or tubing for example. The conduits can also include more valves or other type of conduit arrangement.

As yet another example, while embodiments can be provided so that there is no booster and/or heat exchanger between the nitrogen separation unit 9 and nitrogen storage unit 11, there can be a booster and/or heat exchanger downstream of the nitrogen storage unit 11 to adjust the temperature and/or pressure of the nitrogen output from the nitrogen storage unit 11 for a particular downstream use of the nitrogen gas stored in the nitrogen storage unit 11. For example, the methanol engine unit 13 can include a heat exchanger and/or compressor to increase the temperature or pressure of the nitrogen for a particular application. As another example, the supplemental nitrogen output conduit 18 can be connected to a booster and/or heat exchanger positioned downstream of the nitrogen storage unit 11 to adjust the temperature or pressure of the nitrogen for a downstream application.

Further, the conduits and other elements of the nitrogen generation system NGS can include different types of sensors (e.g. flow sensors, pressure sensors, temperature sensors, purity/composition sensors, etc.) to monitor operation of the system and/or the apparatus. Such elements can be in communication with the controller CTRL and/or an operator device 21, for example.

It should therefore be appreciated that modifications to the embodiments explicitly shown and discussed herein can be made to meet a particular set of design objectives or a particular set of design criteria. For example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of the apparatus for nitrogen generation for methanol powered maritime vehicles, process for nitrogen generation for methanol powered maritime vehicles, and methods of making and using the same have been shown and described above, it is to be distinctly understood that the invention is not limited thereto but may be otherwise variously embodied and practiced within the scope of the following claims.

What is claimed is:

1. An apparatus for nitrogen generation for a methanol powered maritime vehicle, the apparatus comprising:
a compression system configured to compress air to a pre-selected feed pressure and output a compressed air flow at the pre-selected feed pressure; and
a nitrogen separation unit, the nitrogen separation unit positioned downstream of the compression system, the nitrogen separation unit configured to separate nitrogen and oxygen from the compressed air flow fed to the nitrogen separation unit via the compression system, the nitrogen separation unit configured to output the nitrogen separated from the compressed air flow as a nitrogen stream for feeding at least a portion of the nitrogen stream to a nitrogen storage unit.

2. The apparatus of claim 1, wherein the pre-selected feed pressure is between 1300 kilopascals gauge (kPag) and 2000 kPag, and wherein the pre-selected feed pressure is selected so that the nitrogen stream is formed and fed to the nitrogen storage unit without a booster compressor.

3. The apparatus of claim 1, wherein the compression system comprises a compressor and the pre-selected feed pressure is greater than 1300 kPag, and wherein the pre-selected feed pressure is selected so that the compressor of the compression system is the only compressor utilized to separate the nitrogen from the compressed air flow and feed the nitrogen stream to the nitrogen storage unit.

4. The apparatus of claim 1, comprising:
a filtration system having at least one filter element positioned between the compression system and the nitrogen separation unit to filter the compressed air flow before the compressed air flow is fed to the nitrogen separation unit.

5. The apparatus of claim 4, comprising a pretreatment unit positioned between the filtration system and the nitrogen separation unit to pre-heat and/or dry the compressed air flow before the compressed air flow is fed to the nitrogen separation unit.

6. The apparatus of claim 5, comprising the nitrogen storage unit.

7. The apparatus of claim 1, wherein the nitrogen separation unit comprises at least one membrane or comprises an adsorption system.

8. The apparatus of claim 7, wherein the nitrogen separation unit comprises an adsorption system, wherein the adsorption system is a pressure swing adsorption (PSA) system.

9. The apparatus of claim 7, wherein the nitrogen separation unit comprises at least one membrane for forming the nitrogen stream and forming an O2-enriched stream, wherein the O2-enriched stream is output from the nitrogen separation unit and vented.

10. The apparatus of claim 1, wherein the nitrogen stream comprises greater than or equal to 95 volume percent (vol %) N2 and less than 100 vol % N2; and
wherein the maritime vehicle is a ship.

11. The apparatus of claim 1, comprising:
the nitrogen storage unit and a methanol engine unit, the nitrogen storage unit positioned to output nitrogen stored in the nitrogen storage unit to the methanol engine unit via a methanol engine feed conduit positioned between the nitrogen storage unit and the methanol engine unit.

12. The apparatus of claim 11, wherein the nitrogen storage unit is connected to a supplemental nitrogen feed conduit to feed nitrogen to one or more other elements of the maritime vehicle.

13. A process for nitrogen generation for a methanol powered maritime vehicle, the process comprising:
compressing air to a pre-selected feed pressure to output a compressed air flow, the pre-selected feed pressure being between 1300 and 2000 kPag; and
separating the compressed air flow to form a nitrogen stream having between 90 and 100 vol % N2; and
feeding the nitrogen stream to a nitrogen storage unit connected to a methanol engine unit of the methanol powered maritime vehicle.

14. The process of claim 13, comprising:
feeding nitrogen from the nitrogen storage unit to the methanol engine unit for leak testing and/or purging.

15. The process of claim 13, wherein the pre-selected feed pressure is selected so that the nitrogen stream is formed and fed to the nitrogen storage unit without a booster compressor.

16. The process of claim 13, wherein the feed air is compressed by a compression system comprising a compressor, and wherein the pre-selected feed pressure is selected so that the compressor of the compression system is the only compressor utilized to separate the nitrogen from the compressed air flow and feed the nitrogen stream to the nitrogen storage unit.

17. The process of claim 13, comprising:
at least one of:
filtering the compressed air flow upstream of separating the compressed air flow to form the nitrogen stream;
pretreating the compressed air flow to dry and/or pre-heat the compressed air flow upstream of separating the compressed air flow to form the nitrogen stream; and/or
removing oil vapor and/or lubricant from the compressed air flow upstream of separating the compressed air flow to form the nitrogen stream.

18. The process of claim 13, comprising:
detecting a pressure of the nitrogen storage unit;
venting the nitrogen stream and/or deactivating the compression system to stop compressing the feed air if the pressure of the nitrogen storage unit is at or above a first pressure threshold; or
activating the compression system to start compressing the feed air if the pressure of the nitrogen storage unit is at or below a second pressure threshold.

19. An apparatus for nitrogen generation for a methanol powered maritime vehicle, the apparatus comprising:
a compression system configured to compress air to a pre-selected feed pressure and output a compressed air flow at the pre-selected feed pressure;
a nitrogen separation unit positioned downstream of the compression system, the nitrogen separation unit configured to separate nitrogen and oxygen from the compressed air flow fed to the nitrogen separation unit via the compression system, the nitrogen separation unit configured to output the nitrogen separated from the compressed air flow as a nitrogen stream and feed at least a portion of the nitrogen stream to a nitrogen storage unit via a nitrogen storage unit feed conduit connected between the nitrogen storage unit and the nitrogen separation unit;
the nitrogen storage unit connected to a methanol engine unit of the maritime vehicle via a methanol feed conduit to feed nitrogen stored in the nitrogen storage unit to the methanol engine unit;
a nitrogen venting conduit positioned between the nitrogen separation unit and the nitrogen storage unit for venting of at least a portion of the nitrogen stream, the nitrogen venting conduit having a valve;
a sensor configured to detect a pressure of the nitrogen storage unit; and
a controller having a processor in communication with a non-transitory memory, the controller in communication with the sensor and the valve of the nitrogen venting conduit, the controller configured to determine whether the pressure of the nitrogen storage unit is at or above a pre-selected pressure threshold based on data from the sensor and, if the pressure of the nitrogen storage unit is at or above the pre-selected pressure threshold, actuate the valve of the nitrogen venting conduit to adjust the valve of the nitrogen venting conduit to an open position to vent at least a portion of the nitrogen stream and/or communicate with the compression system to adjust operation of the compression system.

20. The apparatus of claim 19, wherein the controller is in communication with the compression system and is configured to deactivate the compression system if the pressure of the nitrogen storage unit is at or above the pre-selected pressure threshold; and
wherein the maritime vehicle is a ship.
